(19) United States
(12) Patent Application Publication
(10) Pub. No.: US 2012/0301660 A1
(43) Pub. Date: Nov. 29, 2012

(54) REINFORCED ADHESIVE TAPE

(75) Inventor: Joseph T. Bartusiak, Osseo, MN (US)

(73) Assignee: 3M Innovative Properties Company

(21) Appl. No.: 13/116,565

(22) Filed: May 26, 2011

(51) Int. Cl. B32B 3/06; D03D 9/00; B32B 9/04; B32B 7/12; B32B 3/00

(52) U.S. Cl. 428/99; 428/343; 428/337; 428/411.1; 442/1

(57) ABSTRACT

Transformable reinforced securing articles and methods are disclosed in which articles are transformable from a highly cinchable tape mode, such as duct tape, through easy physical transformations, to a highly elastic cord-like securing article mode providing relatively high elastic recovery and are capable of repeated usage.

### BACKGROUND

The present description relates to reinforced adhesive tape articles. More particularly, it relates to transformable reinforced securing articles for reinforced adhesive tape articles that are highly cinchable in a tape mode, but also are transformable through easy physical transformation to another mode, wherein a cord-like securing article is formed that exhibits relatively high elastic recovery properties for securing purposes, as well as providing for distinct modes and methods.

Reinforced pressure sensitive adhesive tape articles, such as duct tapes, are widely popular securing elements or devices because of their versatility and adhesive strength. Typically, duct tapes include a backing layer generally coextensive to a reinforcing scrim layer, and a pressure sensitive adhesive layer covering the reinforcing scrim layer. The materials selected for the reinforced adhesive tape articles generally exhibit strength and are normally stretch resistant. They are also generally conformable and adhere to many different substrates having many different surface textures. Moreover, while duct tapes have demonstrated a high degree of versatility because of countless different uses, there are, nevertheless, situations wherein their usage may be relatively limited. In this regard, some reinforced adhesive tape articles, when adhered to uneven substrates (e.g., wrapping and adhering around small diameter pipes or irregularly shaped adherend surfaces) leave spaces or gaps therebetween that may compromise the benefits of intended uses, such as sealing. In addition, many known duct tapes because of their construction tend to be less cinchable than might be otherwise desired. No known commercial types of reinforced adhesive tape articles, such as duct tape articles provide relatively high stretchable, conformable, and cinchable properties.

Accordingly, continuing efforts are being undertaken with respect to improving adhesive tape articles including duct tape articles with improved stretchable, cinchable, and conformable characteristics, particularly relative to known commercial duct tape articles.

Another type of securing element that has enjoyed widespread commercial use and success because of its versatility are highly elastic securing cords, such as bungee cords. These tend to be different both structurally and functionally from commercial duct tapes in several respects. Essentially, bungee cords may be comprised of one or more highly elastic cord-like elements that are wrapped with a woven sheath and rely on their elastic recovery properties for affecting securing. These cords may have hooks or connectors at opposite ends thereof that are normally joinable together or to fixed objects for securing or holding purposes after the cords have been stretched. For example, bungee cords may be utilized to secure equipment on automobile racks; wrap a bundle of items; and the like.

Moreover, duct tape and bungee articles are considered separate and distinct securing devices. No known securing elements or devices combine versatilities and functionalities of a duct tape and a bungee-like cord in the same single-piece construction. In contrast, known tapes, such as duct tapes generally function as tapes, per se, and are not transformable. Moreover, there are no known securing devices that are easily changeable or transformable between the noted distinct states or modes. Furthermore, no known securing devices of the above types are easily transformable from duct tapes to cord-like or bungee-like securing articles having relatively high elastic recovery. Moreover, no known reinforced adhesive tape articles of the above types are easily transformable between the states, as noted above, by a user merely affecting a simple transformation process by applying tensioning forces to the single-piece construction and subsequently releasing such tensioning forces. Consequently, there are no known securing articles allowing users a simple choice of either employing a single-piece article as a highly cinchable reinforced adhesive tape, such as duct tape, and/or as a highly elastic cord-like or bungee-like securing article having relatively high elastic recovery properties.

It is, therefore, highly advantageous to provide reinforced adhesive tape articles and methods thereof that improve upon the versatilities of known securing elements or devices. It is, therefore, highly advantageous to provide reinforced articles adapted for use in adhesive tape articles, such as duct tape, that are highly cinchable. It is also highly advantageous to combine the versatilities and benefits of both reinforced adhesive tape articles, such as duct tapes, and highly elastic articles, such as bungee-like securing articles, in a single-piece construction. Further, in this regard, it is also highly advantageous to provide articles and methods of the above types that combine such functionalities in a single-piece article from an adhesive tape mode to an elastic cord mode through a simple and easy to perform transformation process. Further, in this regard, it is also highly advantageous to provide an elastic cord mode that because of its elastic recovery provides opportunities for repeated usage. In addition, it is highly advantageous to provide articles and methods of the above types that are simple in construction as well as are economical and easy to make and use.

### SUMMARY

The present description is directed to a transformable reinforced securing article that is adapted to be used in a transformable reinforced adhesive tape article. The transformable reinforced securing article comprises: a backing layer having a major surface; and, in combination, a reinforcing layer generally coextensive to and carried by the major surface of the backing layer; the transformable reinforced securing article has a tape configuration that is cinchable and exhibits a tensile strength at break in a range of at least greater than generally about 5 to 20 lb./inch the transformable reinforced securing article exhibits relatively high elastic recovery along with relatively high tensioning forces, the transformable reinforced securing article has a longitudinal axis and longitudinal edges which are transformed by at least curling toward the longitudinal axis in response to application of at least a predetermined tensioning force generally along the longitudinal axis and a relaxation thereof that results in longitudinal extension in an elongation at break range from generally about 150% to 900%; wherein the transformable reinforced securing article exhibits relatively high elastic recovery along with relatively high tensioning forces within the elongation at break range, such that relatively high elastic recovery forces are provided for securing purposes.

The present description is directed to a transformable reinforced adhesive tape article adapted to be used in one mode as a transformable reinforced adhesive tape, and in a second mode as a highly elastic cord-like configuration having relatively high elastic recovery for securing purposes. The transformable reinforced adhesive tape article comprises: a backing layer having a major surface; and, in combination, a reinforcing layer generally coextensive and carried by to the major surface, and an adhesive layer disposed in generally coextensive covering relationship to at least one of the reinforcing layer and the backing layer, the transformable article has a generally tape configuration with longitudinally extending edges and a longitudinal axis in the one mode, and is stretchable, cinchable, and conformable, and, in response to stretching along the longitudinal axis by a predetermined amount and a relaxing of thereof is transformable, whereupon the longitudinally extending edges are transformed by at least curling on themselves toward the longitudinal axis and adopt a cord-like configuration in the second mode that exhibits relatively high elastic recovery along with relatively high tension forces within the elongation at break range.

The present description is directed to a transformable reinforced tape article. The transformable reinforced tape article comprises a backing layer having a major surface; a reinforcing layer generally coextensive to and carried by the major surface of the backing layer; and, in combination, an adhesive layer disposed in generally coextensive covering relationship to at least one of the reinforcing layer and the backing layer; the transformable reinforced tape article is cinchable in one mode and exhibits a tensile strength at break of generally about at least generally about 12 to 14 lb./inch, the transformable reinforced tape article has a tape configuration with a longitudinal axis and longitudinal edges, which longitudinal edges are transformed by at least curling in toward the longitudinal axis in response to application of at least predetermined tensioning force along the longitudinal axis and relaxation of the predetermined tensioning force, whereupon the transformed reinforced tape article in a second mode has an elongation at break range from generally about 500% to 810% and exhibits relatively high elastic recovery along with relatively high tensioning forces within the elongation at break range.

The present description is directed to a method of transforming a transformable reinforced adhesive tape article to a highly elastic cord-like configuration that secures items. The method comprises: providing a transformable reinforced adhesive tape article, wherein the transformable reinforced adhesive tape article includes an elastic backing layer having a major surface, an elastic reinforcing layer in a generally coextensive relation to and carried by the major surface, and, in combination therewith, an adhesive layer disposed in generally coextensive covering relationship to at least one of the reinforcing layer and the backing layer, the transformable article in one mode has a generally tape configuration that is cinchable and a longitudinal axis along with longitudinal edges and, in response to stretching by a predetermined amount along the longitudinal axis and a relaxing thereof, the transformable article transforms from the tape configuration to a cord-like configuration in a second mode having high elastic recovery sufficient to cinch items; and transforming the transformable tape configuration to the cord-like configuration by predetermined tensioning of the article and a relaxing thereof, such that the longitudinal edges are transformed by at least curling in on themselves to form juxtaposed coils and form a cord-like configuration, wherein the transformable article exhibits relatively high elastic recovery along with relatively high tension forces, such that relatively high elastic recovery forces are provided for securing items.

The present description is directed to a cinchable reinforced article that is adapted to be used in combination in a reinforced adhesive tape article. The reinforced article comprises: a backing layer having a major surface; and, in combination, a reinforcing layer generally coextensive to and carried by the major surface; the transformable reinforced securing article has a tape configuration that is cinchable and exhibits a tensile strength at break in a range of at least greater than generally about 5-20 lb./inch; the reinforced and highly elastic article has an elongation at break in a range greater than generally about 60% to about 1200%.

The present description is directed to a method of securing articles in at least two distinct securing modes. The method comprises: providing a transformable reinforced adhesive tape article that is cinchable and includes an elastic backing layer having a major surface, an elastic reinforcing layer generally coextensive to and carried by the major surface, and, in combination therewith, a pressure sensitive adhesive layer in covering relationship to one of the elastic backing layer and the elastic reinforcing layer, the transformable reinforced adhesive tape article has a tape configuration and a longitudinal axis in a first mode of the two distinct securing modes, and, the transformable reinforced adhesive tape article stretches in a first mode and is securable to an object surface along the adhesive layer, the transformable reinforced adhesive tape article is transformed to a cord-like configuration of a second mode of the two distinct securing modes by stretching it along its longitudinal axis by at least a predetermined amount and relaxing it, whereupon the longitudinal edges curl in toward themselves toward the longitudinal axis to form a cord-like configuration that has elasticity sufficient for securing items; securing the pressure sensitive adhesive layer of the tape configuration in the first mode to the object surface; removing the pressure sensitive adhesive layer from the object surface; transforming the removed transformable reinforced adhesive tape article having a tape configuration to an elastic cord-like configuration having high elasticity by tensioning the strip by at least a predetermined amount along the longitudinal axis and relaxing the tensioning, such that the resulting elastic cord-like configuration may be repeatedly used for securing purposes.

### BRIEF DESCRIPTION OF THE DRAWINGS

FIG. 1 illustrates a schematic cross-sectional view of a fragmented portion of one exemplary embodiment of a single-piece, transformable reinforced adhesive tape article made according to the principles of the present description.

FIG. 2 illustrates a schematic cross-sectional view of a fragmented portion of another exemplary embodiment of a single-piece, transformable reinforced adhesive tape article made according to the principles of the present description.

FIG. 3 illustrates a perspective view of a roll of the transformable reinforced adhesive tape article illustrated in FIGS. 1 & 2.

FIG. 4 is a schematic end view of a fragmented longitudinal portion of the transformable reinforced adhesive tape article illustrated in FIG. 1.

FIG. 5 is a schematic end view of a fragmented transformable reinforced adhesive tape article illustrated in FIG. 1 in a mode in which longitudinal edge portions thereof begin to curl in on themselves responsive to longitudinally applied tensioning forces and subsequent relaxation thereof.

FIG. 6 is a view similar to FIG. 5, but illustrating progressive curling or rolling of the longitudinal edge portions toward a centerline or longitudinal axis of the transformable tape article as the elongation or stretching thereof has been increased and subsequently released, such that these edge portions begin to form convoluted coils, such as the type illustrated.

FIG. 7 is a view similar to FIGS. 5-6, but illustrating further progressive rolling or curling of the longitudinal edge portions into juxtaposed convoluted coiled portions.

FIG. 8A is a schematic view illustrating a configuration of a transformable reinforced adhesive tape article prior to being stretched.

FIG. 8B is a schematic view illustrating a configuration of a transformable reinforced adhesive tape article following being stretched by a predetermined amount and subsequently relaxed, whereby it transforms to a highly elastic cord-like configuration having a pair of convoluted coiled portions.

FIG. 9 is a graphical display of the combined tensile stresses at various states of elongation for the exemplary embodiments illustrated in FIGS. 1 & 2.

FIG. 10 is an elevation view of the transformed reinforced adhesive tape article displayed in FIG. 8B, shown being wrapped about several items for bundling purposes.

FIG. 11 is a graphical display of the combined tensile stresses at various elongations of the exemplary embodiment depicted in FIG. 1.

FIGS. 12A-12G are schematic representations of different configurations of a transformable reinforced adhesive tape article.

FIG. 13 is a graphical display of the elastic recovery properties of several samples of exemplary embodiments of a transformable reinforced adhesive tape article made according to the principles of the present description.

### DETAILED DESCRIPTION

According to the present description, shortcomings and limitations of the prior art, as noted, are overcome or minimized by the surprising, unexpected, and versatile results which yield significant advantages relative to known reinforced adhesive tape articles.

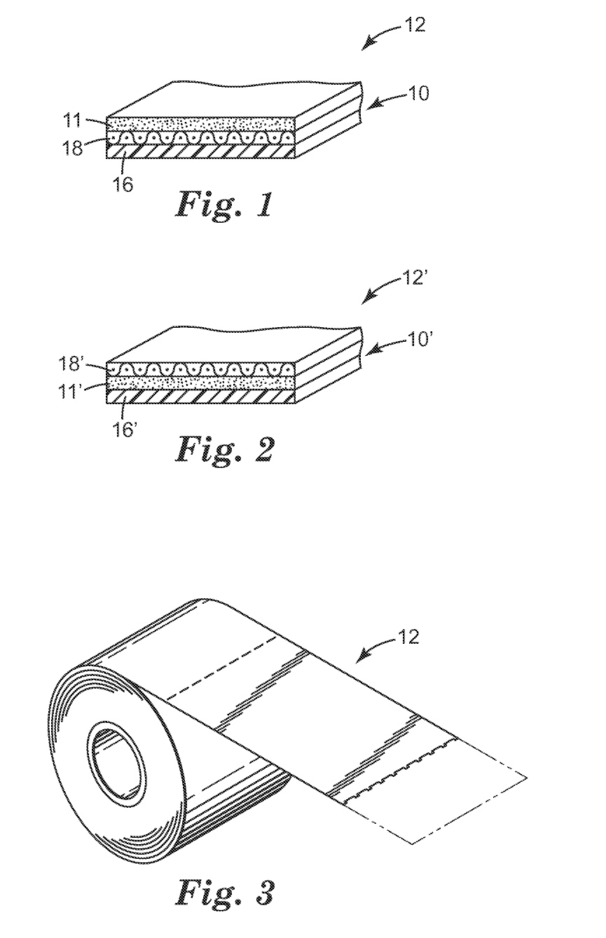

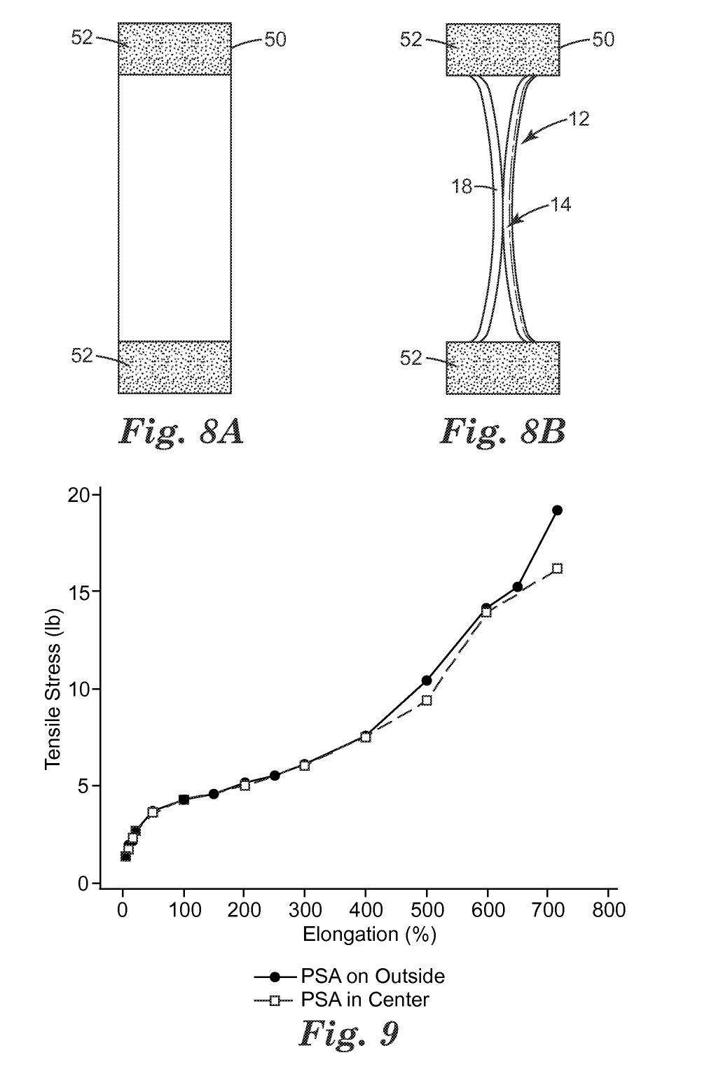

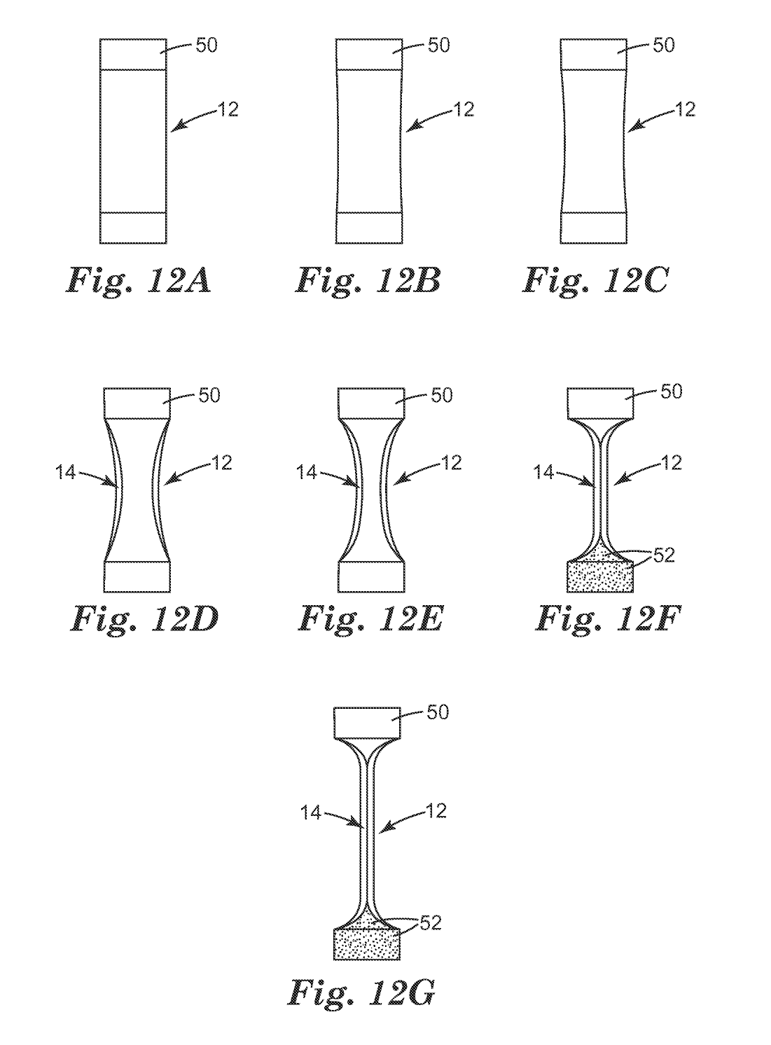

Reference is made to FIGS. 1-13 for illustrating exemplary embodiments of a transformable reinforced securing article 10 adapted to be utilized in a transformable reinforced tape article 12 made according to the principles of the present description, which improves upon known securing tape articles, particularly known commercial duct tapes. In one exemplary embodiment, the transformable reinforced securing article 10 is utilized in combination with an adhesive layer 11 to form the transformable reinforced adhesive tape article 12 having at least two distinct physical modes. As will be described, the transformable reinforced tape article has several distinct states. In a first tape mode, the transformable reinforced adhesive tape article 12 exhibits physical properties that enable its use as a reinforced tape, for example, as a duct tape 12. In a second mode, after the transformable reinforced adhesive tape article 12 has been easily physically transformed by a user stretching it by at least a predetermined amount and relaxing such stretching, the tape article 12 curls along its longitudinal edges into a cord-like securing article 14 (see, e.g., FIGS. 8B & 10). The cord-like securing article may having any one of several different cord-like configurations or states, as, for example, illustrated in, for example, FIGS. 12D-12G that are a function of the degree of stretching. The transformable reinforced tape article 12 may be provided in a roll form (FIG. 3) for normal tape dispensing purposes.

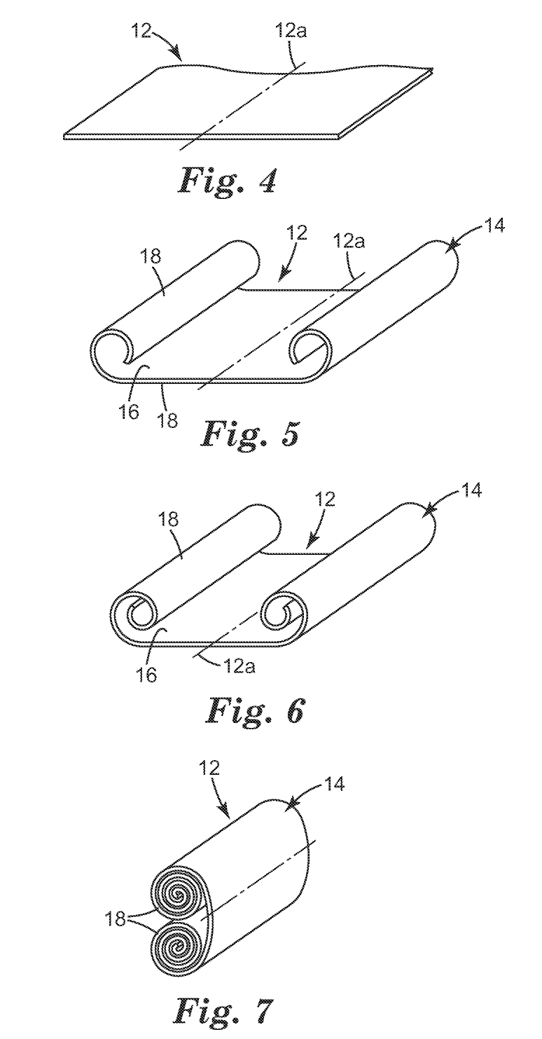

In particular, the transformable reinforced adhesive tape article 12 will, in response to being subjected to stretching or tensioning forces applied along its longitudinal axis 12a (FIGS. 4-6) by a user and then released, undergo physical transformation from the tape mode (FIGS. 1-4) to a cord-like securing article 14. In the cord-like securing article mode, it may have a spindle or cord-like configuration or shape (see, for example, FIGS. 7, 8B, 10 & FIGS. 12D-12G), wherein it exhibits relatively high elastic recovery properties along with relatively high tensioning forces within a preselected elongation at break range, such that relatively high elastic recovery forces are provided in the elongation at break range for enhanced securing. As will be described, physical properties of the transformable reinforced adhesive tape article 12, in the tape mode, such as duct tape 12, enable it to be relatively highly conformable and cinchable, especially when compared to known commercial duct tapes. It will be appreciated that in the duct tape mode, the tape article 12 may be applied as is or may be stretched and conformed before it is applied. If the tape article 12 is not released following stretching, it can be applied as a tape. It will be further appreciated that the tape article when in this tape mode tends to narrow in width as it is stretched, but will not curl into the cord-like configuration unless stretched by predeterminable amounts and the stretching forces are subsequently released. As illustrated, for example, in the exemplary embodiments depicted in for example, FIGS. 5-7, the reinforced layer 18 curls over the backing layer 16 wherein the reinforced layer generally forms the outside or exterior surface of the cord-like article 14. The present description also envisions having the backing layer 16 curl over the reinforced layer 18.

As noted, such a physical transformation occurs in response to a user merely applying tensioning forces along the longitudinal axis 12a (FIGS. 4-6) of the tape article 12 and releasing such forces to allow transformation. The amount of tension applied, as will be explained, is sufficiently large enough in magnitude to exceed the yield point and bring about different elongation extensions of the duct tape before being subsequently released. As will be described and as illustrated, for example, in FIG. 7 & FIGS. 12 D-G, as the amount of stretching tension increases, the amount of induced curling increases, thereby affecting cord-like configurations with different kinds or degrees of curling.

In the exemplary embodiment depicted in FIG. 1, the transformable reinforced securing article 10 essentially includes, in combination, a generally coextensive configuration of an elastic backing layer 16 and an elastic reinforcing layer 18. As noted, the transformable reinforced securing article 10 when joined to at least one elastic adhesive layer 11 forms the transformable reinforced adhesive tape article 12. The adhesive layer 11 may be any suitable adhesive including, but not limited to a pressure sensitive adhesive layer 11. The pressure sensitive adhesive layer 11 may be applied by being extruded in a juxtaposed and generally covering relationship to a major surface of the elastic reinforcing layer 18, which, in turn, has been directly applied to and carried on a major surface of the backing layer 16. Alternatively, another exemplary embodiment of a transformable reinforced securing article 10′ that is illustrated in FIG. 2 and includes the adhesive layer 11′ that forms a center layer that has been applied directly to a major surface of the backing layer 16′ and is essentially covered by the elastic reinforcing layer 18′. As will be described hereinafter, whether the elastic reinforcing layer 18′ is sandwiched, as noted, or positioned as an exterior surface, its positioning does not seem to materially affect the performance of the single-piece, transformable reinforced securing article in any of the noted modes or states, or for that matter limits transformations thereof. While a single adhesive layer is illustrated, it will be appreciated that a second suitable adhesive layer may be provided so that, in essence, a double-sided tape is formed. The adhesive selected should have the strength and other characteristics needed for the purposes intended for a transformable tape article as described herein.

Reference is now made to the elastomeric backing layer 16. The backing layer 16 exhibits elastic properties that typically exceed elongation extension at break properties of backing layers utilized in typical duct tapes, such as those described in U.S. Pat. No. 7,056,844 B2, which latter patent is commonly assigned herewith and incorporated herein by reference. In one exemplary embodiment, the backing layer 16 may exhibit a longitudinal elongation extension at break properties in a range of from generally about 50% to 1200%. The present description also contemplates that with elongation extension at break values of greater than 1200%, the backing layer 16 may be too stretchy for performance as a backing layer when utilized in a combination with the reinforcing layer 18 to form the transformable reinforced adhesive tape article. It is considered that elongation extension at break values of less than 50% may considered too difficult for a commercial duct tape article to adequately stretch and thereby being able for effecting transformation of the kinds described herein, as well as for achieving the cinchabilty or elastic recovery properties. By too difficult to stretch, it is meant that the tensioning forces might be relatively difficult to easily attain by typical users manually stretching.

The backing layer 16 also possesses tensile strength characteristics, which enable it to function well as a reinforced tape article, such as a duct tape that is relatively highly cinchable and yet is able to curl, as will be explained in order to form a cord-like transformable reinforced tape article. In this regard, the backing layer 16 may exhibit tensile strength at break characteristics in a range of generally about at least 5 lb./inch. In another exemplary embodiment, the backing layer 16 may have tensile strength at break characteristics in a range of generally about 5 lb./inch up to about 20 lb./inch. It has been observed that if the tensile strength at break characteristics is in excess of generally about, for example, 16 lb./inch, there may be a likelihood that the backing layer will not be easily extensible enough to be transformed from its duct tape state or mode to its cord-like state or mode. It has also been observed that a more typical range for the tensile strength may be from generally about 10 lb./inch to generally about 14 lb./inch and seems to yield significantly better results. Tensile strength at break characteristics in the last noted range tends to enable the tape to exhibit improved conformability in the duct tape mode compared to known commercial duct tapes. Such conformability allows the backing layer 16 to be more easily wrapped about or otherwise applied and adhered to a variety of adherend surfaces, including but not limited to those having small diameters and/or are irregular or uneven shapes. Also, such a range enables a relatively easy manual stretching by ordinary tape users to facilitate the noted transformations described herein.

The backing layer 16 also possesses a sufficient thickness to not only perform adequately in the intended securing tape mode, as noted, but also enable progressive rolling or curling inwardly of the longitudinal edge portions on themselves to allow formation of convoluted coils and thus the cord-like configurations. It is pointed out that the schematic representations of the curling are only illustrative and are not to be considered limiting. The center of these convoluted coils tend to move towards each other, such that each convoluted coil is juxtaposed to the other curl (e.g., FIG. 7) until a coiled spindle or cord-like configuration, similar to that shown in FIG. 8B and FIGS. 12 D-G results. As such, the thickness of the backing layer 16 may vary depending on the material(s) utilized and the type of functions contemplated for use. In general, for polymeric materials noted above, the thicknesses may typically range from generally about 1 mil to about 4 mils, and, more typically, from generally about 2 mils to 3 mils. It will be appreciated that the foregoing values are by way of illustration and not limitation. Should the thickness be too thin, the reinforced adhesive tape article may break when stretched to the degree intended. On the other hand, if too thick, then the noted curling and coiling attributes might not result in easily achieved convoluted edge portions upon application of stretching forces of the kind described and the corresponding relaxation of such stretching forces. In general, the type of physical properties the transformable reinforced adhesive tape articles are to exhibit during usage determines the thickness range.

The backing layer 16 may be made from materials having physical properties that enable a duct tape to have relatively higher conformability relative to known commercial duct commercial tapes. In addition, such materials allow the relatively easy stretching thereof to affect the noted physical transformation to the cord-like elastic recovery article. The backing layer 16 may be made from a wide variety of materials whose properties are consistent with those described herein. For example, the backing layer 16 may be made from materials that include, but are not limited to polymeric films, such as a group consisting of polyolefins, such as polyethylene including high-density polyethylene, low-density polyethylene, low-density polyethylene, linear low-density polyethylene, ultra low-density polyethylene, polypropylene, polybutylene, polyvinyl, polyurethane and blends and combinations thereof. While polymeric backing layers have been described, the present description envisions other suitable materials as well, including but not limited to non-woven materials in a composite backing construction, ethylene-methyl acrylate copolymers, ethylene-butyl acrylate copolymers, ethylene ethyl acrylate copolymers, ethylene-acrylic acid copolymers, ethylene-methacrylate acid copolymer, ethylene-vinyl acetate copolymers, ethylene-vinyl acetate, acid/acrylate modified copolymers, polypropylene, polybutylene, polyvinyl, polyurethanes, and blends and combinations thereof. In the noted exemplary embodiments described herein in FIGS. 1 & 2, the backing layer is an extruded blend of low-density polyethylene and linear-low density polyethylene, such as is commercially available, under the trade name GF-10 from Pliant Corporation, Schaumberg, Ill., USA.

A reinforcing layer 18 is, as noted, generally coextensively joined by any of the known and suitable techniques in the duct tape field, such as by an adhesive layer being extruded on to such reinforcing layer which laminates the reinforcing layer to the backing layer extrusion through known extruding devices and techniques, on a major surface of the backing layer 16. Other known techniques may be utilized for joining the layers including, but not limited to coating. The reinforcing layer 18 has its physical properties, such as longitudinal extension at break, tensile strength at break, as well as elastic recovery selected so that when used in combination with those of the aforenoted backing layer 16, will enable the functionalities, as noted, in both the duct tape mode and the elastic cord-like mode. In addition, such physical properties also facilitate the relatively easy physical transformation from the duct tape mode to the highly elastic cord-like configuration mode. Such transformation is achieved by merely stretching or pulling on the duct tape with sufficient or predetermined tensioning forces and subsequently releasing such tensioning forces. According to the present description, the reinforcing layer 18 also provides relatively high cinchability forces such that the transformable tape article 12 is more cinchable than known commercial duct tapes. The reinforcing layer 18 should also possess sufficient tensile strength so as it can be used in a duct tape without distorting or breaking during intended usage, as well as enable itself to be torn manually in cross directions or machine directions.

It has been determined that for better results as both a reinforced adhesive tape article and an elastic cord-like securing article, the elongation extension at break may typically be in a range from generally about 500% to 1000%; and, more typically, from about 525% to 800%. However, the elongation at break of the reinforcing layer 18 may fall into a range of from generally about 500% to 1450%; and, more particularly, 600% to 850%. It will be appreciated that a variety of materials having such physical properties may be utilized consistent with the teachings of the present description. For example, the reinforcing layer 18 may be a scrim or netting layer 18. The scrim layer 18 may also have a construction similar to that described in U.S. Pat. No. 7,056,844 which reference is incorporated herein and made a part hereof. The scrim may have other configurations including, but not limited to the exemplary embodiments of netting samples from Conweb Plastics of Minneapolis, Minn., USA. The scrim may be made from natural materials, synthetic materials, or combinations thereof. In the exemplary embodiments, they may be made of from the elastomeric materials listed in Table 1, below. Such materials may be woven and non-woven. The scrim materials further may include a wide variety of materials. The scrim may be made of natural materials, synthetic materials, or combinations thereof. Examples of natural materials include rubber. Examples of synthetic materials include rubber, polyesters, polymers including polyolefin (e.g., polyolefins, polyethylene, and polypropylene), and combinations thereof. Still other scrim materials may include, but not be limited to polyester, fiberglass, acetate, acrylic, modacrylics, rayon, nylon, cotton, polyamine as well as blends and combinations thereof. It will be appreciated that selected scrim materials generally have the physical properties described herein so as to function in a manner provided by the articles and methods of the present description. Also, such scrim materials may be coated and impregnated with other materials.

In regard to the scrim layer, it may have a tensile strength at break in a range of from about 2.5 to about 6.0 lb./inch. These values are by way of illustration and not limitation. The foregoing reinforcing scrim embodiments may have thicknesses that typically fall in the range of about 2 to 37 mils, and more typically in the range of from about 19 to 25 mils. These values are by way of illustration and not limitation. The thicknesses depend generally on the materials utilized in order to achieve the functioning described herein.

Table 1, below, lists samples of the type of scrim materials included in the transformable reinforced tape articles tested. Included in the Table 1 is a description of the trade name of the materials, type of extensibility, basis weight, strand count, tensile strength at break, and elongation percentage used. The tensile strength tests were conducted according to ASTM D822 standards.

TABLE 1

| | | | | Basis | Strand | Tensile | Elongation |
|---|---|---|---|---|---|---|---|
| | | | | Weight | Count | Strength lbf/in | Percentage |
| | | | | lbs per | MD × CD | (Machine | (Machine |
| No. | Sample | Materials | Types | 1000 ft² | per in. | direction) | direction) |
| 1 | Rebound 2500 | Polymeric | Bi- | 24 | 15.0 × 11 | 14.3 | 802 |
| | | Elastomer | directional | PMSF | | | |
| 2 | Rebound5500 | Polymeric | Bi- | 33 | 11.2 × 7.4 | 12.1 | 682 |
| | | Elastomer | directional | PMSF | | | |
| 3 | Rebound 0750 | Polymeric | Bi- | 7.5 | 3.6 × 2.0 | 13.8 | 704 |
| | | Elastomer | directional | PMSF | | | |
| 4 | Poly- | Poly- | Bi- | 347 | 23 × 18 | 54.6 | 550 |
| | urethane | urethane | directional | PMSF | | | |
| 5 | Rebound 2000 | Polymeric | Bi- | 18 | 7 × 5 | 14.2 | 714 |
| | | Elastomer | directional | PMSF | | | |
| 6 | Rebound 1500 | Polymeric | Bi- | 12.5 | 8.1 × 1 | 14.4 | 700 |
| | | Elastomer | directional | PMSF | | | |
| 7 | X-30020-008 | Polymeric | Bi- | 9.25 | 7.4 × 1 | 16.5 | 772 |
| | | Elastomer | directional | PMSF | | | |
| 8 | X-30010 | Polymeric | Bi- | 9.0 | 7.4 × 4 | 14.3 | 730 |
| | | Elastomer | directional | PMSF | | | |
| 9a | X-50020-009 | Polymeric | Uni- | 30 | 7.4 × 12 | 21.5 | 760 |
| | | Elastomer | directional | PMSF | | | |
| 9b | X-50020-009 | Polymeric | Uni- | 30 | 7.4 × 12 | 15.9 | 706 |
| | | Elastomer | directional | PMSF | | | |
| 10a | X-50020-008 | Polymeric | Uni- | 35 | 7.4 × 12 | 23.8 | 707 |
| | | Elastomer | directional | PMSF | | | |
| 10b | X-50020-008 | Polymeric | Uni- | 35 | 7.4 × 12 | 15.7 | 632 |
| | | Elastomer | directional | PMSF | | | |
| 11 | Rebound 5000 | Polymeric | Bi- | 20 | 7.4 × 5 | 19.4 | 718 |
| | | Elastomer | directional | PMSF | | | |

Reference is made back to the pressure sensitive adhesive layer 11. Given the intended use of the transformable reinforced adhesive tape article, the present exemplary embodiments envision use of a pressure sensitive adhesive formulation for the adhesive layer 11 that facilitates its use as a duct tape. Suitable pressure sensitive adhesive systems may be applied continuously as by extrusion or other suitable approaches directly on and generally coextensively as a layer to a major surface of the backing layer 16. Alternatively, the adhesive layer 11 may substantially cover and embed a reinforcing layer 18 that is sandwiched between it and the backing layer 16. The pressure sensitive adhesive layer 11 may be of the type typically used with a duct tape, but which allows the transformable reinforced adhesive securing article 10 to extend and curl as it is being transformed without necessarily breaking its surface. Accordingly, the pressure sensitive layer 11 may have elasticity values and thickness ranges that enable it to perform as contemplated in the transformable reinforced tape article. For example in exemplary embodiments, the thickness of the adhesive may be in a typical range of from about 20 to 40 mils, and in a more typical range of from about 25 to 35 mils. While a pressure sensitive adhesive layer 11 is described in one exemplary embodiment, other suitable adhesive systems, such as hot melt adhesives including a rubber resin hot melt adhesive, thermosetting adhesives, radiation curable adhesives including ultraviolet (UV) adhesives, thermally curable adhesives, and the like may be used. It will be appreciated that exemplary pressure sensitive adhesives may include removable and permanent adhesives. The pressure sensitive adhesives contemplated for use may be selected from a group consisting of organic solvent-based acrylics, waterborne acrylics, silicone adhesives, natural rubber based adhesives, and thermoplastic resin based adhesives. While the adhesive layer is extruded, it may be applied by other suitable approaches, such as but not limited to coating. Examples of pressure sensitive adhesive materials that may be utilized in the exemplary embodiments of FIGS. 1 & 2 include but are not be limited to permanent and releaseable pressure sensitive adhesives, such as are commercially available from 3M Corporation, St. Paul, Minn., USA. For example, a suitable rubber resin type hot melt adhesives may be used in the exemplary embodiments. The pressure sensitive adhesives may also possess other properties, such as, but not limited to being moisture proof, weather proof, and the like.

Reference is now made to Table 2, infra, which represents testing results of physical properties for each of the major components of an exemplary embodiment of the reinforced adhesive tape article 12, as well as values for the entire combination itself. In particular, the values represented include those for tensile strengths at break, elongation extensions at break, tensile stress at yield point, strain at yield point, respectively for the backing layer 16, the reinforcing layer 18, as well as the entire composite sample of reinforced adhesive tape article 12.

The tape sample utilized for generating the results depicted in Table 2 was prepared by generally co-extruding, by a known process, the backing layer 16, and the reinforcing layer 18. The tape sample includes a backing layer 16 made of a blend of low-density polypropylene and linear low-density polypropylene that is commercially available from Pliant Corporation, Schaumberg, Ill., USA, under the trade name GF-10, and a bi-directional elastomeric scrim type reinforcing layer 18 made of a netting or mesh under the trade name Rebound 2500 that is commercially from Conwed Plastics LLC., Minneapolis, Minn., USA. The backing layer 16 had a thickness of 2.25 mils. The pressure sensitive adhesive (PSA) layer was extruded, although it may be coated or applied by any other suitable process. The reinforcing layer 18 may have a thickness of about 19.6 mils. The thickness of the pressure sensitive adhesive had a thickness of about 24.65 mils. The reinforcing layer 18 may be made of a typical rubber resin hot melt adhesive.

TABLE 2

| | Max Load | Strain | | |
|---|---|---|---|---|
| | @ Break | @ Break | Tensile | Strain |
| Sample | (lb./in) | (%0) | @ YP (lb.) | @ YP (%) |
| Film | 11.84 | 721.75 | 1.80 | 12.02 |
| Scrim | 14.27 | 801.67 | 2.12 | 13.74 |
| Film & Scrim & PSA | 19.17 | 717.00 | 2.47 | 14.03 |

As seen in Table 2, the backing layer 16 has a tensile strength at break of about 11.84 lb./inch, the reinforcing layer 18 has a tensile strength at break of about 14.27 lb./inch, and the tensile strength of the composite reinforced adhesive tape article 12 including the pressure sensitive adhesive layer 11 is about 19.17 lb./inch at break. The backing layer 16 has an elongation extension at break of about 721.75%, the reinforcing layer 18 has an elongation extension at break of about 801.67%, and the elongation extension at break of the composite reinforced adhesive tape article 12 is about 717%. The backing layer 16 has a tensile strength at the yield point (YP) of 1.6 lbs.; the reinforcing layer 18 has a tensile strength at the yield point (YP) of 1.6 lbs of 2.2 lbs.; and the tensile strength at the yield point (YP) of the composite reinforced adhesive tape article 12 is 2.47 lbs. The strain at the yield point of the backing layer 16 has a value of 12.02 lbs.; the strain at the yield point of the reinforcing layer 18 has a value of 13.74; and the strain at the yield point of the composite reinforced adhesive tape article 12 has a value of 14.03 lbs. The foregoing values are by way of illustration. It will also be appreciated that the present description envisions that the reinforced and highly elastic article 10 may have an elongation at break in a range from greater than about 60% to about 1200% and still be utilized.

Reference is now made to Table 3, which represents the testing results for various elongations of the two noted different exemplary embodiments of the transformable reinforced adhesive tape articles 12, 12′, respectively. Also, reference is made to FIG. 9, which represents superimposed plots of the testing results of both of the exemplary embodiments listed in Table 3. As noted, the reinforced adhesive tape articles of the two embodiments essentially differed in the positioning of the adhesive layer. However, it will be observed that in terms of the tensile strength at various elongations, the positioning of the adhesive layer is not significantly different. Reference is also made to FIG. 11, which plots the results of the tensile stress at various elongations of the exemplary embodiment listed in Table 3.

The following Comments illustrate observations made regarding the configurations of the tape articles 12, 12′, wherein the tape articles were elongated by different percentage amounts under corresponding different tension forces after the tensioning forces were relaxed.

TABLE 3

| | Embodiment | Embodiment | |
|---|---|---|---|
| | Tape 12 | Tape 12′ | |
| Elongation | Max. Load | Max. Load | |
| (%) | @ Break | @ Break | Comments |
| 5 | 1.33 | 1.29 | Tape configuration |
| 10 | 1.91 | 1.71 | Tape configuration |
| 15 | 2.13 | 2.30 | Tape configuration |
| 20 | 2.67 | 2.63 | Tape configuration |
| 50 | 3.67 | 3.56 | Tape configuration |
| 100 | 4.25 | 4.24 | Tape configuration |
| 150 | 4.56 | — | Tape configuration |
| 200 | 5.13 | 4.97 | Curling of edges begins |
| 250 | 5.53 | — | Curls progress toward Centerline |
| 300 | 6.07 | 6.04 | Curls progress to convoluted |
| | | | coils that move toward |
| | | | longitudinal axis of tape |
| 400 | 7.58 | 7.51 | Curls progress to even tighter |
| | | | convoluted Coils |
| 500 | 10.37 | 9.35 | Convoluted Coils Progress to |
| | | | Cord-like configuration |
| 600 | 14.16 | 13.89 | Convoluted Coils Progress to |
| | | | Tighter Cord-like configuration |
| 650 | 15.24 | — | Convoluted Coils Progress to |
| | | | Even Tighter Cord-like |
| | | | configuration |
| Break | 19.17 | 16.18 | Broken |

In particular, Table 3 represents tensile stress force values at various percentages of longitudinal elongations of each of the two embodiments coupled with observations regarding their induced correspondingly different physical configurations following transformation. In this latter regard, a “Comments” column is provided that lists observations of various physical configurations. For example, the “Comments” column describes that the reinforced adhesive tape articles retain adhesive duct tape characteristics (e.g., generally planar) at certain percentages of elongation even when the tensioning forces are released. Also, the “Comments” column lists at which percentage elongation values the tape articles transform into cord-like securing articles having a “coiled” spindle or a cord-like configuration. It will again be noted, that the observations in the Comments column regarding physical configurations were observed following tensioning of the tape articles and subsequent relaxation thereof.

During the testing of the noted samples, it was observed that the reinforced adhesive tape articles remain in a tape phase having a tape configuration (i.e., generally planar) when it has been stressed to about 150% or less elongation extension and the tension forces released. It will be noted that the reinforced adhesive tape articles that were tested will always remain in a tape mode during stretching only. Accordingly, these samples may be used in a tape mode while being stretched until, for example, the sample breaks or the tensioning forces are relaxed. It is only until the tensioning forces are released does the transformation take place. This is advantageous since a highly stretchable duct tape is provided in one mode when stretched to generally about 150% or less. When the tensioning forces generally stretch it so as to exceed generally 150% and the stretching forces are released, a cord-like securing article is provided as described above. Should such stretching forces that result in 150% or more elongation not be released and the tape is applied to an adherend surface, then provision is made for a highly cinchable duct tape.

Thus, the reinforced adhesive tape article 12 may remain as a tape while it is stretched to, for example, 700%. It was observed that such a duct tape is highly elastic, conformable, and possesses high cinchable properties particularly compared to known commercial duct tapes.

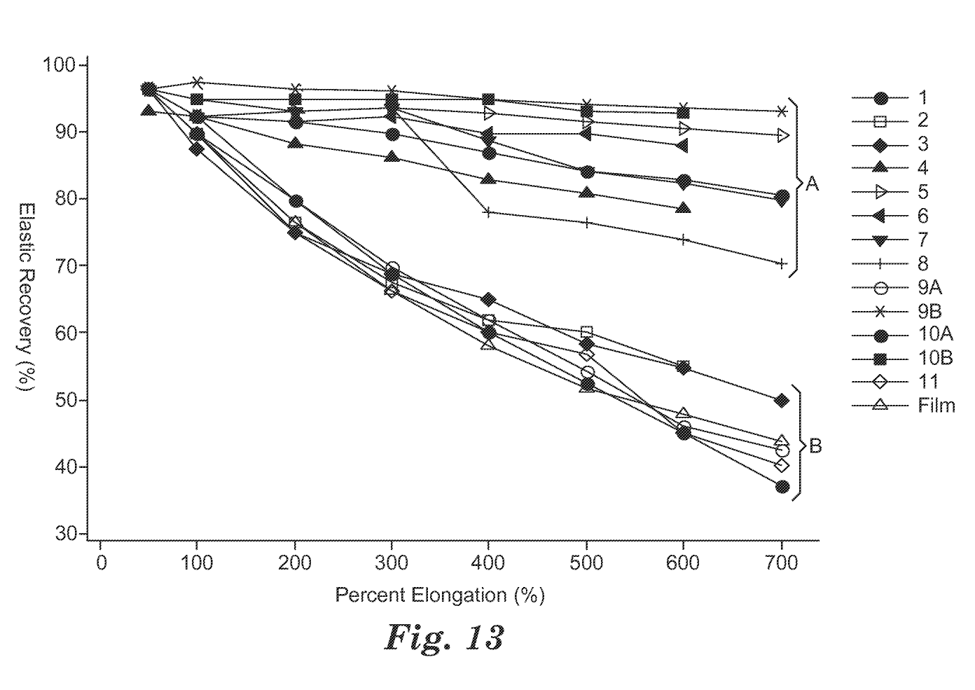

FIGS. 12 A-G represent configurations of a reinforced tape article 12 that are similar to that described in conjunction with FIG. 13. FIG. 12A represents a tape article 12 after being subjected to no elongation. FIG. 12 B represents tape article 12 after being subjected to an elongation of 100% and a relaxation of the tensioning force. FIG. 12 C represents tape article 12 after being subjected to an elongation of 150% and a relaxation of the tensioning force. FIG. 12 D represents tape article 12 after being subjected to an elongation of 200% and a relaxation of the tensioning force. FIG. 12 E represents tape article 12 after being subjected to an elongation of 300% and a relaxation of the tensioning force. FIG. 12 F represents tape article 12 after being subjected to an elongation of 500% and a relaxation of the tensioning force. FIG. 12 G represents tape article 12 after being subjected to an elongation of 650% and a relaxation of the tensioning force.

Reference is made back to Table 3 taken in combination with FIGS. 9, 11, and 12 A-G. It was observed that the sample of the transformable reinforced adhesive tape article 12 listed in Table 2 generally retains its planar tape configuration up to an elongation extension of about 150% elongation. This is beyond the yield point YP (FIG. 11) of the sample. At about 150% elongation, edge portions of the tape slightly curled. At about a 200% elongation, the tape article 12 began to more noticeably transform to a cord-like securing article in that the longitudinal edge portions began to curl even more than before. In this regard, the longitudinal edge portions of the tape article began to curl inwardly toward its longitudinal axis 12a. It will be appreciated that the longitudinal axis is the axis along which the tensioning forces are applied to the samples. The degree of coiling or rolling of the edges in on themselves progresses as the tensile stress continues to increase and as the percent of elongation extension increases. The coiling, in effect, creates a convoluted coiled spindle configuration, FIG. 6. As the elongation extension increases to in excess of 700%, the coiled configurations become tighter or smaller in diameter, such as illustrated in FIG. 7. Each convoluted coiled longitudinal edge may even assume a juxtaposed relationship with each other, such as illustrated in FIG. 7. In this manner, the juxtaposed coiled edges assume a cord-like or spindle configuration, such as illustrated in FIG. 8. In the cord-like spindle configuration of the illustrated embodiment, the adhesive layer forms an exterior surface. Eventually the elongation extension increases under uniaxial tensioning forces until break point is reached.

For example, at about 500% elongation extension, each edge portion assumed a coiled shape similar to those illustrated in FIG. 7. It was observed that when the cord-like spindle configuration had extensions from about 500% to 700%, relatively higher tensioning forces were required by a user (see FIGS. 9 & 11). It will be appreciated that the tensioning forces described herein allow for different users possessing different strengths to relatively easily affect the physical transformation described herein. For example, about nine (9) pounds of tensile stress were required to stretch to about 500% elongation and fourteen (14) pounds of tension were required to stretch to about 700%. These relatively high tensile stresses along with the degree of elastic recovery provided are considered advantageous in providing useful properties for enabling a cord-like elastic recovery article 10 that securely bundles items as might a bungee cord. There is higher cinchabilty because higher tensioning forces are generally required to create extensions above 500% elongation, such that when the tensioning forces are relaxed, the elastic recovery tends to return the transformable article to its near original condition and as such enables relatively strong cinching forces. At longitudinal extensions between about 300-500%, the tensioning forces are less. Longitudinal extensions at about 150-300%, for example, tend to result in partially coiled longitudinal edge portions, see FIGS. 5 & 6 but are associated with less tensile stress and correspondingly less cinchability as the previously noted ranges.

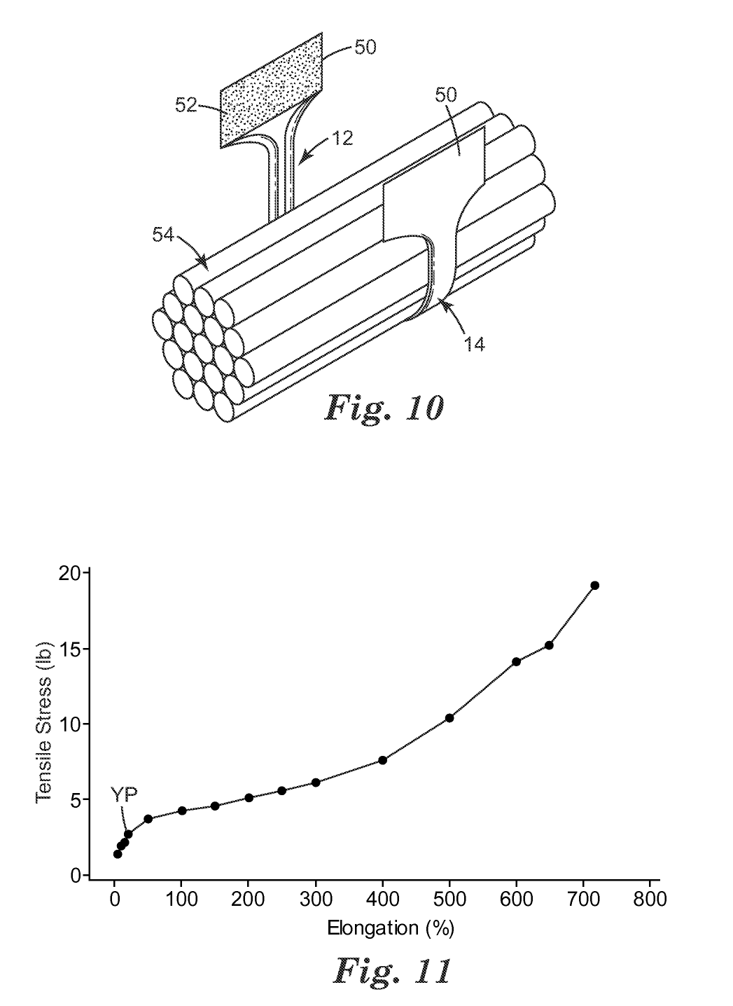

As seen in FIGS. 8A & 8B, the end of the cord-like securing article 14 has a pair of generally rectangular securing tabs 50. The securing tabs 50 may be coextensive with the securing article or they may be doubled or folded over. In either event, one of the end surfaces may have a pressure sensitive adhesive layer 52. The securing tabs 50 may be utilized to secure the cord-like securing article 14 to different adherend surfaces or to themselves if they are going to be used, such as in bundling items 54 (FIG. 10). The securing tabs 50 may be made of same materials as the tape, but are areas generally not stretched since a user would hold them during the kinds of tape stretching described herein. As such, the act of holding the tape article 12 will generally inhibit stretching at the areas where a user holds the tape article. As a result, the tape article will form the securing tabs 50 at such ends being held, whereby the shape and size of the securing tabs generally conform to the area being held by the user. Alternatively, securing tabs may be made of different materials, such as but not limited to non-stretchable materials and materials that will retain their generally planar construction despite the stretching that is done to perform the noted physical transformations. Hooks, clasps and other securing or connecting devices or articles, such as may be used on typical bungee type articles can replace the securing tabs or be attached to the securing tabs.

Elastic recovery results of the total tape construction of the exemplary embodiment of the reinforced adhesive tape article 12, duct tape 12 construction set forth in Table 2. Elastic recovery tests were conducted according to ASTM D5454 standards.

TABLE 4

| Percent Elongation | Elastic Recovery |
|---|---|
| of Total Tape | of Total Tape |
| Construction (%) | Construction (%) |
| 50 | 96.67 |
| 100 | 92.50 |
| 200 | 91.67 |
| 300 | 90.00 |
| 400 | 87.00 |
| 500 | 84.70 |
| 600 | 82.98 |
| 700 | 80.74 |

From Table 4, the elastic recovery for one exemplary embodiment of a tape construction of the transformable reinforced adhesive tape article 12 made, as noted above, had an elastic recovery that would range from about 96.67% to about 84.70% for longitudinal elongation extensions from 50% to about 500% and about 82.98% elongation at 600% elongation extension and about 80.74% elongation at 700% elongation extension. The foregoing example does not intend to limit the scope of the present description. Other samples of the elastic recovery of other exemplary embodiments are set forth in regard to Tables 5 and 6, infra.

TABLE 5

| | Max Load | Strain | Tensile | Strain |
|---|---|---|---|---|
| | @ Break | @ Break | @ YP | @ YP |
| Sample | (lb./in) | (%0) | (lb.) | (%) |
| 2 | 12.09 | 661.5 | 2.81 | 17.81 |
| 3 | 13.79 | 703.83 | 1.86 | 14.18 |
| 4 | 54.56 | 549.83 | 7.03 | 20.51 |
| 5 | 14.20 | 713.67 | 1.94 | 13.53 |
| 6 | 14.39 | 700.83 | 1.68 | 13.31 |
| 7 | 16.53 | 771.67 | 2.18 | 13.51 |
| 8 | 14.27 | 729.50 | 1.91 | 13.40 |
| 9a | 21.49 | 760.33 | 8.46 | 25.22 |
| 9b | 15.94 | 705.83 | 2.46 | 17.92 |
| 10a | 23.83 | 707.00 | 10.39 | 12.85 |
| 10b | 15.70 | 632.33 | 2.37 | 16.63 |
| 11 | 19.38 | 718.17 | 2.72 | 16.89 |

Table 5 lists for samples 2-11 the tensile strength at break and the elongation at break of the exemplary embodiments of reinforced adhesive tape articles 12, duct tape 12 construction that utilize the corresponding different scrim samples listed in Table 1. The samples 2-11 were used with the backing layer described for sample 1 used in Table 2 as well as the adhesive layer described in sample 1 of Table 2. FIG. 11 illustrates the display of the combined tensile stresses at various elongations for these samples that were tested in a manner described above for sample 1. It will be appreciated that the samples 2-11 generally follow the plot of the tensile stress at various elongations for sample 1.

Also, the elastic recovery for the samples 2-11 are listed below in Tables 6A-6C. Reference is also made to FIG. 13, which plots the results of the elastic recovery at various elongations of the specimens or samples 2-11 listed in Tables 6A-6C.

TABLE 6A

| | Elastic | Elastic | Elastic | Elastic |
|---|---|---|---|---|
| Percent | Recovery | Recovery | Recovery | Recovery |
| Elongation | of | of | of | of |
| of | Total Tape | Total Tape | Total Tape | Total Tape |
| Total Tape | Construction | Construction | Construction | Construction |
| Construction | (%) | (%) | (%) | (%) |
| (%) | SAMPLE 2 | SAMPLE 3 | SAMPLE 4 | SAMPLE 5 |
| 50 | 96.67 | 96.67 | 93.33 | 96.67 |
| 100 | 90.00 | 87.50 | 92.50 | 92.50 |
| 200 | 76.67 | 75.00 | 88.33 | 91.67 |
| 300 | 67.50 | 68.75 | 86.25 | 92.50 |
| 400 | 62.00 | 65.00 | 83.00 | 93.00 |
| 500 | 60.00 | 58.33 | 80.83 | 91.67 |
| 600 | 55.09 | 54.80 | 78.59 | 90.63 |
| 700 | NA | 49.78 | NA | NA |

TABLE 6B

| Percent | Elastic | Elastic | Elastic | Elastic |
|---|---|---|---|---|
| Elongation | Recovery of | Recovery of | Recovery of | Recovery of |
| of | Total Tape | Total Tape | Total Tape | Total Tape |
| Total Tape | Construction | Construction | Construction | Construction |
| Construction | (%) | (%) | (%) | (%) |
| (%) | SAMPLE 6 | SAMPLE 7 | SAMPLE 8 | SAMPLE 9A |
| 50 | 96.67 | 96.67 | 96.67 | 96.67 |
| 100 | 92.50 | 92.50 | 95.00 | 92.50 |
| 200 | 91.67 | 93.33 | 93.33 | 80.00 |
| 300 | 92.50 | 93.75 | 93.75 | 70.00 |
| 400 | 90.00 | 89.00 | 76.00 | 62.00 |
| 500 | 90.00 | 84.17 | 76.67 | 54.17 |
| 600 | 87.89 | 82.52 | 72.98 | 45.95 |
| 700 | NA | 79.87 | 70.45 | 42.31 |

TABLE 6C

| Percent | | | | |
|---|---|---|---|---|
| Elongation | Elastic | Elastic | Elastic | Elastic |
| of | Recovery of | Recovery of | Recovery of | Recovery of |
| Total Tape | Total Tape | Total Tape | Total Tape | Total Tape |
| Construc- | Construction | Construction | Construction | Construction |
| tion | (%) | (%) | (%) | (%) |
| (%) | SAMPLE 9B | SAMPLE 10A | SAMPLE 10B | SAMPLE 11 |
| 50 | 96.67 | 96.67 | 96.67 | 96.67 |
| 100 | 97.50 | 90.00 | 95.00 | 90.00 |
| 200 | 96.67 | 80.00 | 95.00 | 75.00 |
| 300 | 96.25 | 68.75 | 95.00 | 66.25 |
| 400 | 95.00 | 60.00 | 95.00 | 60.00 |
| 500 | 94.17 | 52.50 | 93.33 | 56.67 |
| 600 | 93.52 | 44.94 | 93.09 | 45.08 |
| 700 | 73.17 | 37.08 | NA | 40.00 |

Tables 6A-6C represent the elastic recovery at various elongations of the scrim samples listed in Table 1 as well as for the backing film 16 or backing layer 16 that was used in the exemplary embodiment of the transformable reinforced tape article 12 set forth in Table 2. It will be appreciated that the higher the elastic recovery values are at the elongations associated with the tape article being in a cord-like configuration, taken together with the relatively high tensile stresses required to get those extensions, see FIG. 11, the relatively more useful the tape article is in behaving as cord-like securing article when transformed as noted. It is seen that there are a group of scrim samples (as seen in FIG. 13), collectively Samples A, that tends to exhibit even better results than those scrim samples (as seen in FIG. 13), collectively Sample B. It is seen that the elastic recovery for the group of Samples A, where in a range of from about 70% to about 97%. This range was relatively higher than the range of elastic recovery for the same variations of elongations as the group of scrim materials of Samples B, wherein the elastic recovery range was from about 35% to about 97%. As a result, the group of scrim materials of Sample A provides a greater degree of elastic recovery than those of Sample B and accordingly a greater degree of elasticity.

According to the present description, it is an aspect of the present description to provide a single reinforced adhesive article and method of making that combines in a single securing article the combined versatilities and functionalities of a duct tape in one mode or state and a highly elastic, bungee-like, cord in another mode or state. Furthermore, it is another aspect of the present description to provide a single reinforced adhesive article, such as duct tape, that is easily transformable from its state, as a stretchable, conformable, and cinchable tape-securing element, to at least another state as a highly elastic cord-like or bungee-like securing element. It is still an aspect of the present description to provide a reinforced adhesive article that combines the versatilities of a duct tape and bungee cord in a single securing element. Moreover, it is an aspect of the present description to provide a single reinforced adhesive article of the above types that is easily transformable from its state as a tape-securing element to at least another state as a highly elastic cord-like securing element through a simple transformation process. It is a further aspect of the description to provide a single reinforced adhesive article of the above types that provide different elastic functionalities in the elastic cord-like securing element. It is still another aspect of the present description to provide a reinforced article adapted to be used as a reinforced adhesive tape article and methods of making that combines functionality of duct tape in one mode and is transformable to a bungee-like cord in another mode, and yet is economical to manufacture.

The words “a”, “an”, and “the” are used interchangeably with “at least one” to mean one or more of the elements being described. By using words of orientation, such as “top,” “bottom,” “overlying,” “front,” and “back” and the like for the location of various elements in the disclosed respirators, we refer to the relative position of an element with respect to a horizontally-disposed body portion.

The above experimental data illustrated in the above Tables and the charts demonstrate the materials used and the dramatic effect brought about by the improved reinforced article to provide a highly useful reinforced adhesive tape article that is able to function in at least two distinct modes for securing articles.

The present disclosure may take various modifications and alterations without departing form the spirit and scope. Accordingly, this disclosure is to be controlled in the limitations set forth in the following claims and any equivalents thereof.

The present disclosure may also be suitably practiced in the absence of any element not specifically disclosed herein. All patents and publications noted above including any in the Background section are incorporated by reference into this document in total.

What is claimed is:

1. A transformable reinforced securing article comprises: a backing layer having a major surface; and, in combination, a reinforcing layer generally coextensive to and carried by the major surface of the backing layer; the transformable reinforced securing article has a tape configuration that is cinchable and exhibits a tensile strength at break in a range of at least greater than generally about 5 to 20 lb./inch the transformable reinforced securing article exhibits relatively high elastic recovery along with relatively high tensioning forces, the transformable reinforced securing article has a longitudinal axis and longitudinal edges which are transformed by at least curling toward the longitudinal axis in response to application of at least a predetermined tensioning force generally along the longitudinal axis and a relaxation thereof that results in longitudinal extension in an elongation at break range from generally about 150% to 900%; wherein the transformable reinforced securing article exhibits relatively high elastic recovery along with relatively high tensioning forces within the elongation at break range, such that relatively high elastic recovery forces are provided for securing purposes.

2. The transformable article of claim 1, wherein the longitudinal edges are able to progressively curl towards each other to define a pair of coiled portions juxtaposed to each other in a generally cord-like configuration in response to the transformable article being stretched in a range of generally about 300% to 800% elongation and released.

3. The transformable article of claim 1, wherein the tensile strength at break is in a range of from generally about 10-14 lb./inch.

4. The transformable article of claim 1, wherein the elastic recovery is in a range of generally about 35% to 97%.

5. The transformable article of claim 1, wherein the elastic recovery is in a range of generally about 70% to 97%.

6. The transformable article of claim 5, wherein the high tension forces are in a range of from generally about 8-12 lbs.

7. The transformable article of claim 2, further including at least a longitudinal end portion thereof which does not curl when held to prevent stretching and is usable for securing end portions of the cord-like configuration to an adherend surface.

8. The transformable article of claim 1 further including a generally coextensive adhesive layer on at least one major surface of the backing layer and the reinforcing layer.

9. The transformable article of claim 8, wherein the adhesive layer comprises at least an adhesive system from a group consisting of at least one of pressure sensitive adhesives, thermosetting adhesives, radiation curable adhesives including ultraviolet curable adhesives, thermally curable adhesives, and any combinations thereof.

10. The transformable article of claim 1, wherein the backing layer is made of at least one of a group of polymeric elastomeric materials that consists of: polyolefin elastomers, polypropylene elastomers, polyvinyl elastomers, polyurethane elastomers, and any combinations thereof.

11. The transformable article of claim 1, wherein the reinforcing layer is made of a reinforcing scrim material that is highly extensible and in a range from generally about 500% to 1450%.

12. The transformable article of claim 11, wherein the reinforcing scrim material is from a group of materials that consists of natural materials and synthetic materials, or combinations thereof, wherein the natural materials include rubber, and wherein the synthetic materials include synthetic rubber, polyesters, polymers including polyolefin (e.g., polyolefins, polyethylene, and polypropylene); and any combinations thereof.

13. The transformable article of claim 11, wherein the backing layer has a thickness within a range of generally about 1 to 4 mils.

14. The transformable article of claim 9, wherein the pressure sensitive adhesive material is from a group consisting of natural rubber, synthetic rubber, synthetic elastomers, acrylates, and blends, and combinations thereof.

15. A transformable reinforced adhesive tape article adapted to be used in one mode as a reinforced adhesive tape, and in a second mode as a highly elastic cord-like configuration that secures items, the article comprises: a backing layer having a major surface; and, in combination, a reinforcing layer generally coextensive to and carried by the major surface, and an adhesive layer disposed in generally coextensive covering relationship to at least one of the reinforcing layer and the backing layer, the article has a generally tape configuration with longitudinally extending edges and a longitudinal axis in the one mode, and is stretchable, cinchable, and conformable, and, in response to stretching along the longitudinal axis by a predetermined amount and relaxing thereof, the longitudinally extending edges are transformed by at least curling on themselves toward the longitudinal axis and adopt a cord-like configuration in the second mode that exhibits relatively high elastic recovery along with relatively high tensioning forces within the elongation at break range, such that relatively high elastic recovery forces are provided for securing items.

16. The transformable reinforced adhesive tape article of claim 15, further including at least a longitudinal end portion which when held so as not to stretch can be used for securing to adherend surfaces.

17. A method of transforming a transformable reinforced adhesive tape article to a highly elastic cord-like configuration that secures items, the method comprises: providing a transformable reinforced adhesive tape article, wherein the transformable reinforced adhesive tape article includes an elastic backing layer having a major surface, an elastic reinforcing layer in a generally coextensive relation to and carried by the major surface, and, in combination therewith, an adhesive layer disposed in generally coextensive covering relationship to at least one of the reinforcing layer and the backing layer, the transformable article in one mode has a generally tape configuration that is cinchable and a longitudinal axis along with longitudinal edges and, in response to stretching by a predetermined amount along the longitudinal axis and a relaxing thereof, the transformable article transforms from the tape configuration to a cord-like configuration in a second mode having high elastic recovery sufficient to cinch items; and transforming the transformable tape configuration to the cord-like configuration by predetermined tensioning of the article and a relaxing thereof, such that the longitudinal edges are transformed by at least curling in on themselves to form juxtaposed coils and form a cord-like configuration, wherein the transformable article exhibits relatively high elastic recovery along with relatively high tension forces, such that relatively high elastic recovery forces are provided for securing items.

18. The method of claim 17, wherein the provided transformable article retains its tape configuration in the one mode until generally about an 800% elongation of the provided transformable article.

19. A cinchable reinforced article adapted to be used in combination in a reinforced adhesive tape, the reinforced article comprises: a backing layer having a major surface; and, in combination, a reinforcing layer generally coextensive to and carried by the major surface; the transformable reinforced securing article has a tape configuration that is cinchable and exhibits a tensile strength at break in a range of at least greater than generally about 5 to 20 lb./inch; the reinforced and highly elastic article has an elongation at break in a range from greater than generally about 60% to 1200%.

20. The cinchable article of claim 19, wherein and the predetermined amount includes longitudinally extending the article in a range of from generally about 300% to 800% elongation.
